(19) United States
(12) Patent Application Publication
(10) Pub. No.: US 2013/0272466 A1
(43) Pub. Date: Oct. 17, 2013

(54) CRDM Divert Valve

(71) Applicants: Michael J. Edwards, Forest, VA (US); Matthew W. Ales, Forest, VA (US); John D. Malloy, III, Goode, VA (US)

(72) Inventors: Michael J. Edwards, Forest, VA (US); Matthew W. Ales, Forest, VA (US); John D. Malloy, III, Goode, VA (US)

(21) Appl. No.: 13/528,217

(22) Filed: Jun. 20, 2012

Related U.S. Application Data
(60) Provisional application No. 61/625,212, filed on Apr. 17, 2012.

(51) Int. Cl. G21C 7/06

(52) U.S. Cl. 376/230

(57) ABSTRACT

A valve for controlling flow of high pressure fluid to a CRDM hydraulic latching mechanism of a nuclear reactor core. The valve includes a valve body having an inlet for receiving fluid from a fluid source, an outlet, and a dump port for dumping fluid backflow. A valve member is movable within the valve body between a first position restricting flow between the outlet and the dump port such that high pressure fluid entering the valve body through the inlet exits the valve body through the outlet, and a second position whereat the dump port is in fluid communication with the outlet such that at least a portion of any backflow fluid flowing back into the valve body via the outlet exits the valve body via the dump port.

### BACKGROUND

The following relates to the nuclear power reactor arts, nuclear reaction control apparatus arts, control rod assembly arts, and related arts.

Pressurized water reactors traditionally utilize neutron-absorbing control rods that are moved into or out of the nuclear reactor core in order to control the reactivity. The control rods are operated by control rod drive mechanisms (CRDMs) that are mounted on the reactor vessel head. Penetrations in the head allow connecting rods from the control rod cluster to extend outside of the reactor vessel and connect to the CRDMs. These CRDMs use magnets to latch the rods to the roller nut or mag jack assemblies in the CRDMs to pull the control rod clusters out of the core.

In some current reactor designs, the CRDMs are located inside the reactor vessel. See, e.g. U.S. Pub. No. 2010-0316177 A1 published Dec. 16, 2010 which is incorporated herein by reference in its entirety, and U.S. Pub. No. 2011-0222640 A1 published Sep. 15, 2011 which is incorporated herein by reference in its entirety. In some such “internal” CRDM designs, the connecting rods are contemplated to be latched to the CRDM assembly by a hydraulic actuating mechanism that relies on hydraulic pressure to prevent the rods from dropping free from the CRDMs. That is, a hydraulic actuating mechanism is biased to a released or disengaged state and hydraulic pressure is supplied to the hydraulic actuating mechanism to maintain the actuating mechanism in an engaged state during normal operation of the reactor. This provides failsafe operation as loss of hydraulic power (either intentionally or due to some hydraulic system malfunction) would result in a SCRAM.

### BRIEF SUMMARY

In accordance with one aspect, a valve for controlling flow of coolant to a hydraulic latching mechanism of an internal control rod drive mechanism (CRDM) disposed inside a nuclear reactor comprises a valve body having an inlet for receiving coolant, an outlet connectable to a hydraulic latching mechanism for supplying coolant thereto, and a dump port for dumping backflow coolant, a valve member movable within the valve body between a first position restricting flow between the outlet and the dump port such that coolant entering the valve body through the inlet exits the valve body through the outlet, and a second position whereat the dump port is in fluid communication with the outlet such that at least a portion of any backflow coolant flowing back into the valve body via the outlet exits the valve body via the dump port, a biasing element positioned to bias the valve member towards the second position, wherein coolant flowing into the valve body via the inlet acts on the valve member to urge the valve member towards the first position against the biasing element.

In accordance with another aspect, a nuclear reactor comprises a nuclear reactor core comprising fissile material, a pressure vessel containing the nuclear reactor core immersed in primary coolant disposed in the pressure vessel, and a valve mounted to the pressure vessel for controlling flow of coolant to a CRDM hydraulic latching mechanism. The valve comprises a valve body having a coolant inlet for receiving coolant from a coolant source, a coolant outlet connectable to a hydraulic latching mechanism for supplying coolant thereto, and a dump port for dumping coolant backflow, a valve member movable within the valve body between a first position restricting flow between the coolant outlet and the dump port such that coolant entering the valve body through the coolant inlet exits the valve body through the coolant outlet, and a second position whereat the dump port is in fluid communication with the coolant outlet such that at least a portion of any backflow fluid flowing back into the valve body via the coolant outlet exits the valve body via the dump port a biasing element positioned to bias the valve member towards the second position. The coolant flowing into the valve body via the coolant inlet acts on the valve member to urge the valve member towards the first position against the biasing element.

In accordance with another aspect, a valve comprises a valve body having a coolant outlet, a coolant inlet, a biasing element, and a flange configured to mount the valve on a pressure vessel of a nuclear reactor with the valve body including the coolant outlet disposed inside the pressure vessel and the coolant inlet and the biasing element disposed outside the pressure vessel, and a divert assembly disposed in or with the valve body and configured to be held in a flow position by coolant flow passing through the valve from the coolant inlet to the coolant outlet and biased by the biasing element toward a divert position that diverts the coolant outlet to discharge into the pressure vessel upon removal of the coolant flow.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 is a schematic diagram of an exemplary reactor in accordance with the disclosure.

FIG. 2 is a perspective cutaway view of an exemplary flow divert valve in accordance with the disclosure.

FIG. 3 is an enlarged portion of FIG. 2 showing the exemplary flow divert valve in a first position.

FIG. 4 is similar to FIG. 3 but illustrates the flow divert valve in a second position.

### DETAILED DESCRIPTION OF THE PREFERRED EMBODIMENTS

When tripping a reactor that employs a CRDM with a hydraulic latch (for example, as described in U.S. Pub. No. 2011-0222640 A1 published Sep. 15, 2011 which is incorporated herein by reference in its entirety), or when release of the control rods from the hydraulic actuating mechanism is otherwise desired or warranted, the hydraulic pressure must be released and backflow must be initiated to allow water in the hydraulic latch cylinders to escape before the control rods can be released. In one approach, a separate pipe is provided to dump water from the hydraulic latch cylinder to an accumulator with sufficient free volume to accommodate the fluid. A set of valves is configured to close off the water from the supply pumps while simultaneously draining the water that is in the CRDM latching cylinders back to the reactor cooling system (RCS). This approach requires small bore piping to run from the mid-flange to the dump valve and back to the mid-flange. Since this is a safety-related operation, redundant dump valves are typically provided in case one dump valve fails. If the piping that supplies water to the latching cylinders breaks, the flow through that pipe is limited by the leakage rate past the latch cylinder seals. However, if the piping that returns the fluid to the RCS breaks, the result is a significant loss of cooling accident (LOCA).

As disclosed herein, the coolant from the CRDM can instead be dumped directly into the pressure vessel, e.g. into the downcomer region. Intuitively, this might seem to be problematic since the pressure vessel is at elevated pressure, which indeed may be increasing in an uncontrolled manner in the event of a reactor malfunction leading to a SCRAM. However, it is recognized herein that because the hydraulic latching cylinder of the internal CRDM is immersed in primary coolant contained in the pressure vessel, the pressure inside the cylinder is always higher than the pressure in the pressure vessel because of the weight supported by the hydraulic cylinder. Thus, there is always a positive differential pressure available to drive the water out of the cylinder and into the pressure vessel. Moreover, since the hydraulic latching cylinders typically cannot be guaranteed to be fully sealed against leakage, the working fluid in the hydraulic latching cylinders is typically taken from the reactor coolant inventory and purification system (RCI) system, and so dumping it into the pressure vessel does not introduce any coolant contamination issues. As disclosed herein, the hydraulic fluid supply line used to pressurize the cylinder can be modified to dump water from the cylinder into the pressure vessel when the hydraulic pressure is turned off. Thus, the disclosed approach does not add any additional external piping for discharging the cylinder (removing a potential LOCA source) and provides passive discharge of the cylinder without the use of dump valves (removing another potential failure mechanism).

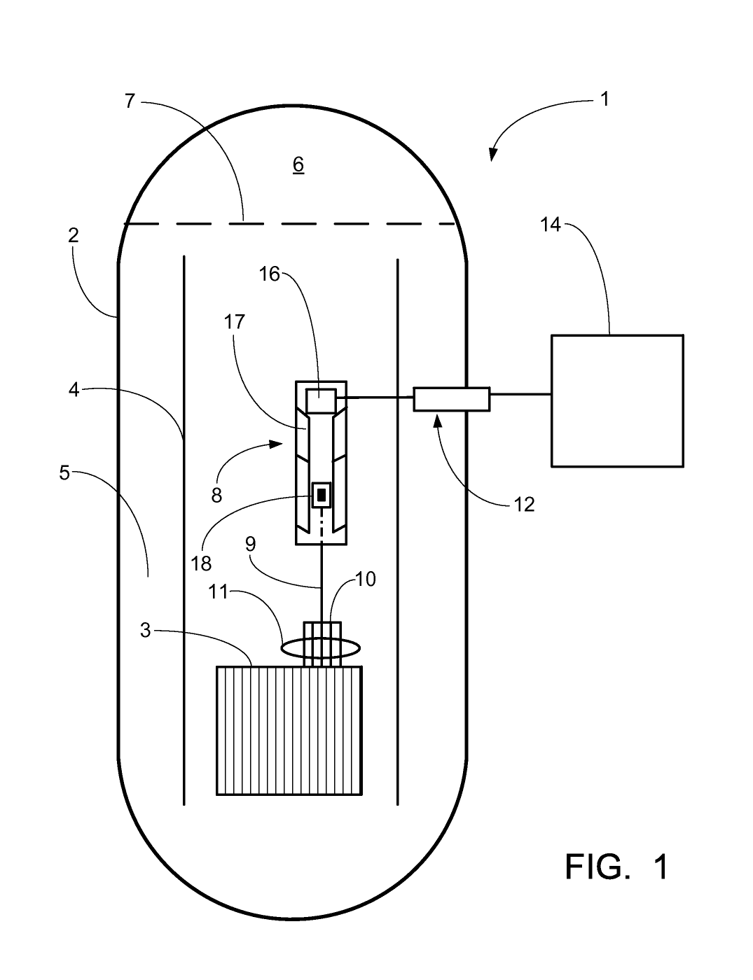

Turning now to the drawings, and initially to FIG. 1, an exemplary nuclear reactor in accordance with the disclosure is illustrated and identified generally by reference numeral 1. The illustrative nuclear reactor is of the pressurized water reactor (PWR) variety, and includes a pressure vessel 2 containing a reactor core 3 comprising fissile material (e.g., ²³⁵U) immersed in primary coolant water. The illustrative pressure vessel 2 is generally cylindrical, and a generally cylindrical central riser 4 disposed coaxially inside the pressure vessel 2 defines a coolant circulation path in which primary coolant heated by the reactor core 3 flows upward through the central riser 4, exits the top of the central riser 4 and flows downward back to the core 3 through a downcomer annulus 5 defined between the pressure vessel 2 and the central riser 4. The primary coolant in the pressure vessel 2 is maintained in a subcooled state by pressure provided by an internal pressurizer 6 at the top of the pressure vessel 2 defined by a baffle plate 7 (or, alternatively, the pressure vessel can be connected with an external pressurizer via suitable piping.) It will be appreciated that the reactor 1 is merely illustrative of one type of reactor, and that the flow divert valve of the present disclosure can be used with a wide variety of reactors.

As noted above, one type of internal control rod drive mechanism (internal CRDM) utilizes hydraulic pressure to maintain latching force on the control rod drive connecting rods. In FIG. 1, one such CRDM 8 is shown disposed inside the volume enclosed by the central riser 4. The CRDM 8 operates on a control rod assembly including a connecting rod 9 terminating in a spider 10 that supports an assembly of neutron-absorbing control rods 11. The CRDM 8 includes a motor/leadscrew assembly (not shown) for raising/lowering the control rod assembly 9, 10, 11 such that the control rods 11 are raised from the core 3 or lowered into the core 3. The CRDM receives hydraulic pressure from a hydraulic trip divert valve 12 that is fed from a pressurized fluid source 14, such as the RCI 14. During normal operation, the hydraulic pressure is supplied to a hydraulic latching cylinder 16 of the CRDM 8. The pressure raises a piston of the hydraulic cylinder 16 that in turn lifts a cam assembly 17 that causes a latch 18 to secure to the upper end of the connecting rod 9. The cam assembly 17 includes long vertical arms that are coextensive with the travel of the latch 18 during raising/lowering of the control rod assembly 9, 10, 11, and cam bars of the cam assembly 17 drive the vertical arms generally inward to engage the latch 18 when the cylinder 16 is pressurized. If hydraulic pressure is removed from the cylinder 16 then the piston falls under force of gravity, and the cam assembly 17 drives its vertical arms outward away from the latch 18, which then releases the connecting rod 9 causing the control rod assembly 9, 10, 11 to fall toward the reactor core 3 under force of gravity. Further details of the CRDM 8 including the hydraulic latching cylinder 16, cam assembly 17, and latch 18 are described in U.S. Pub. No. 2011-0222640 A1 published Sep. 15, 2011 which is incorporated herein by reference in its entirety. (Note that in FIG. 1, the reactivity control components 8, 9, 10, 11 are drawn at an enlarged scale as compared with the remainder of the reactor for visual clarity—more generally, the dimensions of FIG. 1 are diagrammatic and are not to scale. Also, only one CRDM 8/control rod assembly 9, 10, 11 is shown—there is an array of such CRDM/control rod assemblies provided, typically one per fuel assembly of the reactor core 3). In one arrangement, a differential pressure between the latch cylinder 16 and ambient conditions in the reactor (that is, the pressure of the coolant inside the pressure vessel 2) is needed to keep the piston of the latch cylinder 16 raised so as to engage the latch 18 to prevent dropping the control rods 11 into the reactor core 3 and initiating a reactor shutdown. The trip (unlatching of the rods) is not instantaneous, however. Once pressure to the cylinder(s) is terminated, there is a finite amount of water in the latching cylinders (˜one gallon total) that must be drained before the pistons can move far enough to release the control rods. Thus, there is a delay before the control rods release as this water drains from the pistons. It should be noted that the foregoing pressure and volume values are illustrative examples for a contemplated PWR with internal pressurizer and internal CRDMS, and other pressure/volume values may be used in other designs.

The hydraulic trip divert valve 12 is shown in FIG. 1 mounted to a vessel penetration of the pressure vessel 2 and extends into the downcomer annulus 5. The divert valve 12 receives pressurized fluid from the RCI 14. (Because of this, any leakage of the hydraulic fluid from the cylinder 16 is not problematic since it is purified reactor coolant). Fluid received by the divert valve 12 is directed to one or more hydraulic latching cylinders 16 of one or more CRDM devices 8. The divert valve 12 provides an internal valve that, upon actuation, allows water in the CRDM latching cylinders 16 and associated tubing to drain back into the downcomer annulus 5 of the reactor pressure vessel 2. This configuration eliminates the external piping and the dump valve, and therefore, eliminates the possibility of a LOCA from that piping and the possibility of a dump valve actuation failure.

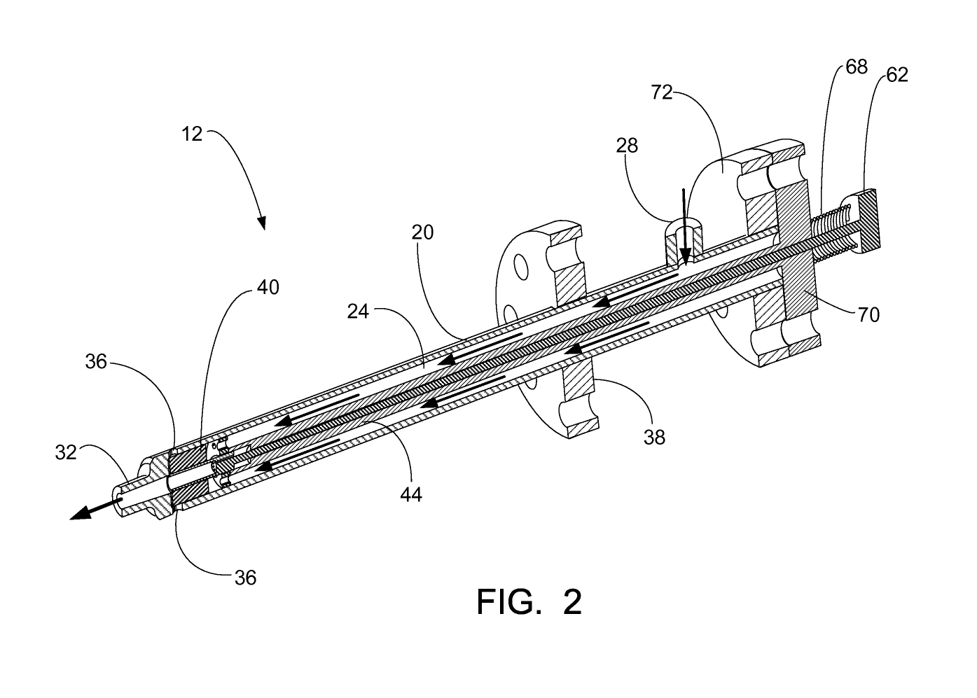

Turning to FIG. 2, a cross-sectional view taken through a longitudinal axis of an exemplary divert valve 12 is shown. The illustrated exemplary divert valve 12 utilizes the flow received from the RCI 14 to maintain the valve in a position that passes that flow into a pipe that leads to the CRDM latching cylinders 16. If the flow from the high pressure source 14 is interrupted for any reason (e.g., an unintentional blockage or an intentional automatic or manual shutoff of the hydraulic flow to initiate a SCRAM) then a spring outside of the reactor pressure boundary shifts the valve to a second position where flow received back from the CRDM latching cylinders would drain into a reactor vessel downcomer 5.

The divert valve 12 generally includes a valve body 20 having an axially extending central bore 24 defining a passageway between an inlet, hereinafter referred to as a high pressure inlet 28, for receiving high pressure fluid, such as coolant, from a high pressure fluid source, and an outlet, hereinafter referred to as high pressure outlet 32, connectable to a hydraulic latching mechanism for supplying the pressurized fluid thereto. As will be appreciated, the fluid may typically be a coolant such as the type commonly used in nuclear reactors, but other types of fluid can be used. A plurality of dump ports 36 open to an external surface of the valve body 20 and, as will be described, allow fluid to dump directly to a downcomer 5 of the reactor vessel 2 during a reactor shutdown. An attachment or mounting flange 38 is provided for bolting or otherwise securing the valve 12 to a pressure vessel such that the high pressure outlet 32 is disposed within the pressure vessel and the high pressure inlet 28 is disposed outside the pressure vessel. It should be appreciated that other mounting configurations are possible, and that in some instances both the high pressure inlet 28 and the high pressure outlet 32 may be disposed within the pressure vessel.

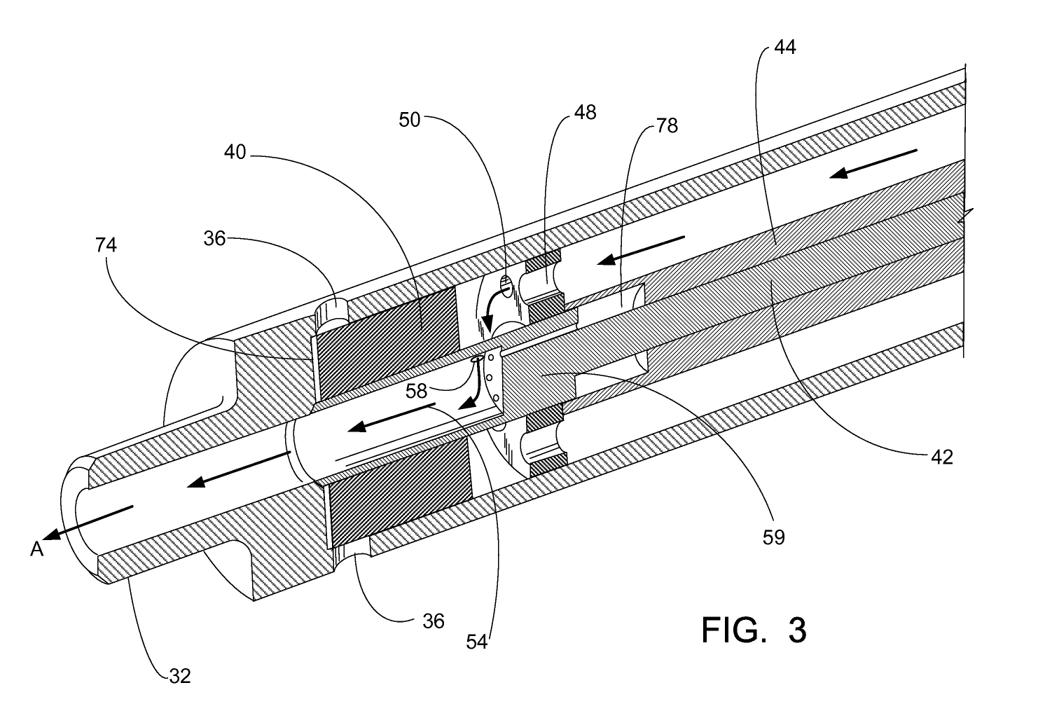

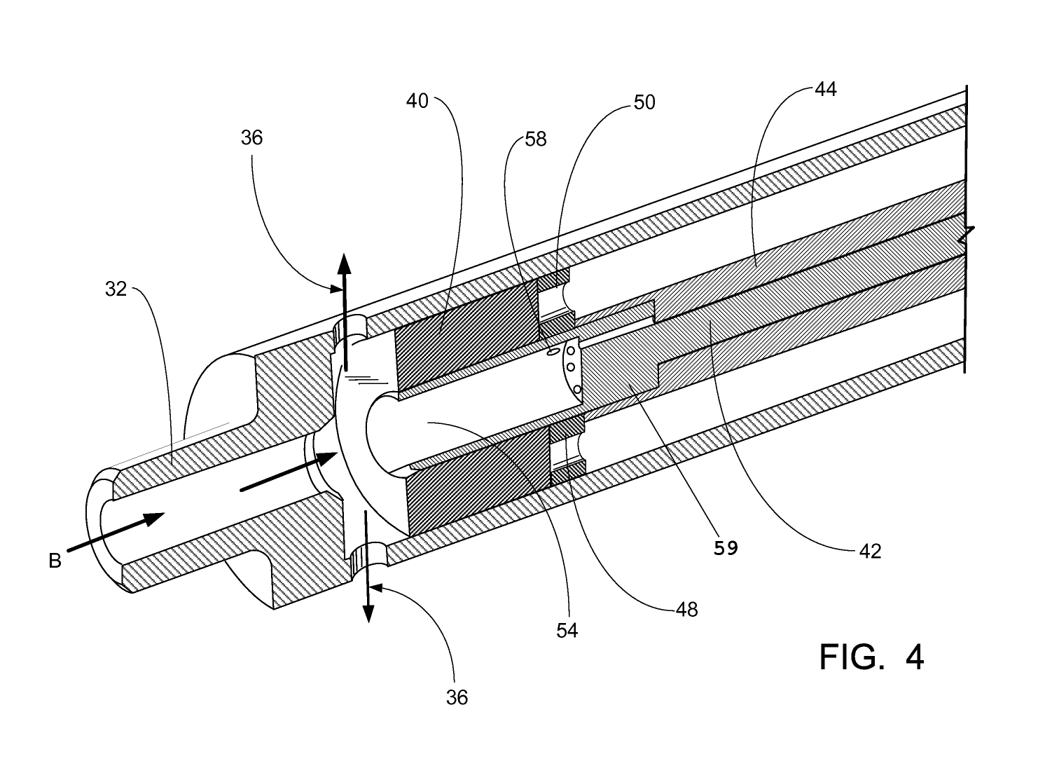

With further reference to FIGS. 3 and 4, supported within the central bore 24 of the valve body 20 is a valve member in the form of a divert piston 40. Divert piston 40 is supported for reciprocating movement within the central bore 24 and is movable between a first position and a second position, as will be described below. It will be noted that the piston 40 includes a rod portion 42 that is supported within the central bore 24 by a rod support member 44. The rod support member 44 has at its axially inner end a radially outwardly extending flange 48 that engages an inner surface of the central bore 24. The flange 48 has a plurality of flow passages 50 that allow the flow of fluid between the high pressure fluid inlet 28 and the high pressure fluid outlet 32 when the piston 40 is in the first position. Fluid flowing through flow passages 50 enters a central cavity 54 in the piston 40 via radial ports 58 in a reduced diameter portion 59 of the piston 40, then flows to high pressure outlet 32. It should be understood that the flow of high pressure fluid through the valve body in this manner acts to maintain the piston 40 in the first position shown in FIG. 3.

Returning to FIG. 2, rod portion 42 protrudes from the valve body 20 and has a spring flange 62 adapted to engage a spring 68 or other biasing element. Spring 68 is interposed between said spring flange 62 and a base portion 70 of the rod support member 44 such that the piston 40 and rod portion 42 of the valve member are biased towards the second position shown in FIG. 4, as will be described below.

It should be appreciated that the rod support member 44, valve member including piston 40 and rod portion 42, and the spring 68 can be inserted into the central bore 24 of the valve body 20 as a unit. To this end, these components can be part of a valve member assembly that can be assembled outside of the valve body 20, and can inserted therein and bolted or otherwise secured to a base flange 72 of the valve body 20. Accordingly, the piston 40 and/or spring 68 etc. can be easily replaced or swapped out without removal of the valve body 20 from its position within a pressure vessel or the like.

In operation, high pressure fluid is supplied to the high pressure inlet 28. Fluid flows into the central bore of the valve body 20 in the annular space between the rod support member 44 and the valve body 20. The fluid passing through the flow passages 50 of the flange 48 acts upon the piston 40, forcing the piston 40 to the position shown in FIG. 3. As the piston 40 is moved, the spring 68 is compressed between spring flange 62 and the base portion 70 of the rod support member 44. As will be appreciated, when piston 40 is forced to the left (position shown in FIG. 3), the radial ports 58 in the reduced diameter portion of the piston 40 are revealed, allowing the high pressure fluid flowing through the central bore 24 from the high pressure inlet 28 to enter the central cavity 54 of the piston 40. The fluid then flows out of the valve body 20 via high pressure outlet 32. The flow path of fluid flowing through the valve 12 between the high pressure inlet 28 and the high pressure outlet 32 when the piston 40 is in this first positioning is illustrated by arrows A in FIG. 3.

In the first position shown in FIG. 3, the piston 40 blocks flow of fluid between both the high pressure inlet 28 and outlet 32, and the dump ports 36, such that any high pressure fluid entering the valve body 20 through the high pressure inlet 28 is directed to the high pressure outlet 32. In this regard, the piston 40 is in abutting engagement with an internal axial end face 74 of the central bore 24. In this position, the dump ports 36 are blocked by the radial outer surface of the piston 40. Further sealing can be provided via sealing elements disposed in the axial mating faces of the piston 40 and the central bore, and/or disposed at the circumferential interface of the piston 40 and central bore 24. In some applications, it should be appreciated that a small amount of leakage may exit the valve body 20 through dump ports 36 even when the piston is in the first position.

When high pressure fluid is no longer supplied to the high pressure inlet 28, such as during a SCRAM or other shutdown of a reactor where it is desired to release the latching mechanism(s) holding the control rods to the CRDM, the spring 68 acts to shift the piston 40 to the second position shown in FIG. 4. That is, upon stoppage of high pressure flow to the high pressure inlet 28, the hydraulic forces maintaining the piston 40 in the position of FIG. 3 are generally removed. Thus, spring 68 begins to retract piston 40 to its second position, as fluid pressure backflowing into the high pressure outlet 32 from the cylinder(s) of the latching mechanism also acts on the piston 40 in a common direction with the spring 68.

Accordingly, the piston 40 shifts to the position of FIG. 4 such that the reduced diameter portion 59 of the piston 40 is received in a counterbore 78 of the rod support member 44 thereby closing radial ports 58 and axial passages 50, and also revealing dump ports 36. This effectively isolates the high pressure inlet 28 from the high pressure outlet 32, and directs backflowing fluid received in the high pressure outlet 32 to the dump ports 36, where such fluid flows out of the valve body 20 into the downcomer or other flow region within the pressure vessel. The direction of such flow is illustrated by arrows B in FIG. 4. Suitable seals can be provided on at least one of the piston 40, valve body 20, and/or flange 48 for preventing leakage of backflowing fluid.

In an illustrative embodiment, the valve body can be approximately three inches in outside diameter and configured to bolt onto the outside of a reactor. The valve can be configured to penetrate the pressure vessel and can be connected to piping that transports high pressure water to the one or more CRDM latching mechanisms. High pressure fluid received from redundant pumps, for example, enters the valve outside of the pressure vessel and flows through an annular region as described until it reaches the divert piston. There, the fluid is forced to turn and pass through one or more orifices to reach the flow path in the center of the piston, for example as seen in the valve of FIG. 3. The orifices are sized to create sufficient force to hold the piston against the back face of the valve body compressing a spring on the front face of the valve (outside of the reactor coolant).

If the pump flow is interrupted by a fast acting block valve, for example, the hydraulic pressure on the face of the piston is lost. The spring will accelerate the piston to the open position (FIG. 4) blocking flow back to the pumps via the high pressure inlet and allowing fluid in the CRDM latching mechanisms to flow into the reactor vessel. In one exemplary configuration, the full stroke of the piston can be approximately 0.9 in. Neglecting friction in the valve packing, and assuming a desired spring force, the valve will move to the full open position in less than a second in one configuration, and in less than a tenth of second in another configuration wherein the spring force is more desirous. Friction will substantially increase operating time but sufficient force should be available to operate the piston quickly. Other than the packing at the spring end of the valve, component clearances can be large minimizing binding and friction. With proper thermal design, the preload spring can be located within the pressure boundary eliminating the need for valve packing if an external actuator is not used. It will be appreciated that the spring can influence the speed at which the valve shifts, as well as initiate movement of the valve after removal of inflow pressure.

The flow divert valve disclosed herein automatically opens when the hydraulic pumps are de-activated to provide a short path for water to flow from the CRDM latching cylinders to the RCS inside the vessel. The divert valve eliminates the need for pipe to direct flow back into the vessel or to an alternative reservoir. When the divert valve opens to allow CRDMs flow to the RCS, it also isolates the RCS from flow paths outside of the reactor, preventing significant LOCA flow in the event of a pipe break outside of the reactor vessel.

The valve arrangement shown and described in FIGS. 1-4 utilizes hydraulic pressure received from a source, for example one or more pumps, to position the valve to direct flow to the CRDMs. A separate isolation valve may therefore be used to move the divert valve to the tripped position. That is, the isolation valve could be configured to block flow from the high pressure source to the high pressure inlet to initiate valve state change. Alternatively, an actuator can be mounted on the divert valve to perform this function. It can be a fail open actuator such as a linear pneumatic type that holds the valve in the normally operating position while relying on the preload spring to move the valve piston when the CRDMs are to drop the rods. Another alternative could utilize an actuator to force the valve into normal operating position where it would be restrained by a solenoid actuated latch. Loss of electrical power to the solenoid would release that latch allowing the spring to move the divert valve.

The divert valve is described with illustrative reference to the CRDM 8 with a hydraulic latch (for example, as described in U.S. Pub. No. 2011-0222640 A1 published Sep. 15, 2011 which is incorporated herein by reference in its entirety). More generally, the divert valve can be used in conjunction with any type of CRDM employing a hydraulic cylinder designed to initiate a scram upon removal of hydraulic power. For example, the disclosed divert valves can be used in conjunction with a CRDM that employs a separable coupling to the lead screw that is maintained in the engaged state by positive hydraulic pressure. The disclosed divert valve can also be used in conjunction with a dedicated shutdown rod assembly that employs a pressurized hydraulic cylinder to keep the shutdown rods withdrawn from the reactor core. See, e.g. U.S. Pub. No. 2010-0316177 A1 published Dec. 16, 2010 which is incorporated herein by reference in its entirety. Still more generally, the disclosed divert valve is suitably used in any context in which a hydraulic piston is disposed inside a pressure vessel of a nuclear reactor and is advantageously discharged of hydraulic fluid upon removal of hydraulic power. In addition to the disclosed application in conjunction with an internal CRDM with hydraulic latching, other contemplated applications include hydraulic cylinders operating other systems disposed in the pressure vessel, such as a failsafe internal valve in which loss of positive hydraulic pressure causes a piston to fall under gravity so as to close the valve.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. A valve for controlling flow of coolant to a hydraulic latching mechanism of an internal control rod drive mechanism (CRDM) disposed inside a nuclear reactor, the valve comprising:
a valve body having an inlet for receiving coolant, an outlet connectable to a hydraulic latching mechanism for supplying coolant thereto, and a dump port for dumping backflow coolant;
a valve member movable within the valve body between a first position restricting flow between the outlet and the dump port such that coolant entering the valve body through the inlet exits the valve body through the outlet, and a second position whereat the dump port is in fluid communication with the outlet such that at least a portion of any backflow coolant flowing back into the valve body via the outlet exits the valve body via the dump port;
a biasing element positioned to bias the valve member towards the second position;
wherein coolant flowing into the valve body via the inlet acts on the valve member to urge the valve member towards the first position against the biasing element.

2. A valve as set forth in claim 1, wherein the valve body includes a cylinder, and wherein the valve member includes a piston supported for reciprocating movement within the cylinder between the first and second positions.

3. A valve as set forth in claim 2, wherein the piston is configured to seal against an interior surface of the cylinder to restrict flow from an interior of the cylinder to the dump port when the piston is in the second position.

4. A valve as set forth in claim 2, wherein the piston is supported in the cylinder between the inlet and the outlet, and the piston includes at least one flow orifice through which coolant can flow between the inlet and the outlet regardless the position of the piston within the cylinder.

5. A valve as set forth in claim 2, wherein the biasing element includes a spring for applying a preload to the piston for biasing the piston towards the second position.

6. A valve as set forth in claim 5, wherein the preload applied to the piston is generally less than the force applied to the piston by the coolant flowing into the valve body via the inlet such that, when the fluid pressure flowing into the inlet exceeds a threshold value, the piston is moved to the first position.

7. A valve as set forth in claim 1, further comprising a mounting flange for mounting the valve to an associated pressure vessel, wherein the mounting flange is disposed axially between the inlet and the outlet such that when the valve is mounted to the associated pressure vessel, the inlet is outside the associated pressure vessel and the outlet in inside the pressure vessel.

8. A nuclear reactor comprising:
a nuclear reactor core comprising fissile material;
a pressure vessel containing the nuclear reactor core immersed in primary coolant disposed in the pressure vessel; and
a valve mounted to the pressure vessel for controlling flow of coolant to a CRDM hydraulic latching mechanism;
wherein the valve comprises:
a valve body having a coolant inlet for receiving coolant from a coolant source, a coolant outlet connectable to a hydraulic latching mechanism for supplying coolant thereto, and a dump port for dumping coolant backflow;
a valve member movable within the valve body between a first position restricting flow between the coolant outlet and the dump port such that coolant entering the valve body through the coolant inlet exits the valve body through the coolant outlet, and a second position whereat the dump port is in fluid communication with the coolant outlet such that at least a portion of any backflow fluid flowing back into the valve body via the coolant outlet exits the valve body via the dump port;
a biasing element positioned to bias the valve member towards the second position;
wherein coolant flowing into the valve body via the coolant inlet acts on the valve member to urge the valve member towards the first position against the biasing element.

9. A nuclear reactor as set forth in claim 8, wherein the valve body includes a cylinder, and wherein the valve member includes a piston supported for reciprocating movement within the cylinder between the first and second positions.

10. A nuclear reactor as set forth in claim 9, wherein the piston is configured to seal against an interior surface of the cylinder to restrict flow from an interior of the cylinder to the dump port when the piston is in the second position.

11. A nuclear reactor as set forth in claim 9, wherein the piston is supported in the cylinder between the coolant inlet and the coolant outlet, and the piston includes at least one flow orifice through which fluid can flow between the coolant inlet and the coolant outlet regardless of the position of the piston within the cylinder.

12. A nuclear reactor as set forth in claim 9, wherein the biasing element includes a spring for applying a preload to the piston for biasing the piston towards the second position.

13. A nuclear reactor as set forth in claim 12, wherein the preload applied to the piston is generally less than the force applied to the piston by the coolant flowing into the valve body via the coolant inlet such that, when the pressure of the coolant flowing into the coolant inlet port exceeds a threshold value, the piston is moved to the first position.

14. A nuclear reactor as set forth in claim 8, wherein the valve further comprises a mounting flange for mounting the valve to an associated pressure vessel, wherein the mounting flange is disposed axially between the coolant inlet and the coolant outlet such that when the valve is mounted to the associated pressure vessel, the coolant inlet is outside the associated pressure vessel and the coolant outlet in inside the pressure vessel.

15. An apparatus comprising:
a valve including:
a valve body having a coolant outlet,
a coolant inlet,
a biasing element, and
a flange configured to mount the valve on a pressure vessel of a nuclear reactor with the valve body including the coolant outlet disposed inside the pressure vessel and the coolant inlet and the biasing element disposed outside the pressure vessel, and
a divert assembly disposed in or with the valve body and configured to be held in a flow position by coolant flow passing through the valve from the coolant inlet to the coolant outlet and biased by the biasing element toward a divert position that diverts the coolant outlet to discharge into the pressure vessel upon removal of the coolant flow.

16. An apparatus as set forth in claim 15, wherein the divert assembly of the valve includes a valve member movable within the valve body between a first position corresponding to the flow position, and a second position corresponding to the divert position.

17. An apparatus as set forth in claim 16, wherein the valve body of the valve includes a cylinder, and wherein the valve member includes a piston supported for reciprocating movement within the cylinder between the first and second positions.

18. An apparatus as set forth in claim 17, wherein the piston is supported in the cylinder between the coolant inlet and the coolant outlet, and the piston includes at least one flow orifice through which fluid can flow between the coolant inlet and the coolant outlet regardless of the position of the piston within the cylinder.

19. An apparatus as set forth in claim 15, further comprising:
a nuclear reactor including a nuclear reactor core comprising fissile material and a pressure vessel containing the nuclear reactor core immersed in primary coolant disposed in the pressure vessel;
wherein the valve is mounted on the pressure vessel of the nuclear reactor by the flange of the valve with the valve body including the coolant outlet disposed inside the pressure vessel and the coolant inlet and the biasing element disposed outside the pressure vessel.

20. An apparatus as set forth in claim 19, further comprising:
a control rod assembly (CRA) including a plurality of control rods arranged for insertion into the nuclear reactor core; and
an internal control rod drive mechanism (CRDM) disposed inside the pressure vessel of the nuclear reactor and operatively coupled with the CRA, the internal CRDM including a hydraulic cylinder configured to (1) maintain operative connection of the CRDM with the CRA when pressurized by hydraulic power and (2) release the CRA to initiate a scram upon removal of hydraulic power; and
a reactor coolant inventory and purification system (RCI) system supplying hydraulic power to the hydraulic cylinder of the CRDM via the valve mounted on the pressure vessel of the nuclear reactor.
